(19) United States
(12) Patent Application Publication
(10) Pub. No.: US 2013/0080094 A1
(43) Pub. Date: Mar. 28, 2013

(54) Device for Depth of Energy Prediction of a Battery and a Method for the Same

(71) Applicant: Neotec Semiconductor Ltd., Chu-Pei City (TW)

(72) Inventor: Kuo-Liang Teng, Taoyuan County (TW)

(73) Assignee: NEOTEC SEMICONDUCTOR LTD., Chu-Pei City (TW)

(21) Appl. No.: 13/628,133

(22) Filed: Sep. 27, 2012

(30) Foreign Application Priority Data
Sep. 27, 2011 (TW) 100134904

(51) Int. Cl. G06F 19/00

(52) U.S. Cl. 702/63; 702/85

(57) ABSTRACT

A device for predicting remaining capacity of a battery and a method for the same are disclosed. The device is embedded in a battery pack or externally coupled thereto. The device includes a program for proceeding an algorithm of cell capacity calculation, a database stored in a non-volatile memory having a table of open-circuit voltage, a table of current gain and a capacity conversion equation. The program generates a discharging curve according to the cell temperature and load accessed and corrects the database according to the battery voltage and the discharging curve and the coulomb counter.

### FIELD OF THE INVENTION

The present invention pertains to an algorithm for predicting a depth of energy of a battery and the device for the same, particularly to an algorithm using the temperature of the battery detected and the load current outputting therefrom as parameters to predict a depth of energy of the battery.

### DESCRIPTION OF THE PRIOR ART

Battery is knows as a main power for most of probable electric devices. For instance, the mobile phone, notebook, PDA (personal digital assistance), Walkman, etc., all rely on the battery to provide the electrical power for the devices properly work The battery, however, saves only limited electrical capacity. As a probable device is turned on, the charges saved in the battery consumed will sustain. While the residue electrical capacity is not enough to support the probable device work properly, the battery management unit will force a power management program to store the necessary parameters into hard disk or nonvolatile memory and then turned off the power. The latter represents that the electricity stored in the battery is lower than a critical level. For the earth environment and the average cost are concerned, choosing the rechargeable battery for the probable device as the main power is generally taken.

A lithium battery associated with a good battery management integrate chip may make the lithium battery be recharged for several hundreds or even thousands without make the battery material premature. In addition to the high times of recharging for a good battery, a user may more concern about the accurately remaining run-time estimated by the battery management of a mobile device when the user is using the device. Since the remaining run-time need to be known in mind by the user so that the user can appropriately close the current work before the power management program informs the user that the device is prepared to be turned off for protecting the battery if the user does not plug-in AC (alternatively current) power or a charger immediately.

Moreover, a good power management program is demanded to accuracy predict the remaining battery capacity and the remaining run-time all the time in accordance with the discharging rate rather than turning off the battery after it has been discharged to a certain low level. A high quality battery management is necessary.

However, providing such a high quality battery management system is expensive according to the conventional technologies known by the inventors. The battery management system designers have to spend a rather long time to build a database, even worse, the database established by the designers according to a first battery manufacturer may be not apt to a second battery manufacturer it is because the data records in the database are highly relied on the chemical material in the batteries, particularly to the grades of the material vary. Therefore, the IC designers have to repeat developing procedures of the database again for the second battery manufacturer as that of first battery manufacturer.

For accuracy the predicting residual capacity in accordance with a method of dynamic discharge cutoff voltage, the battery has to be fully charged and then completely discharged for hundreds of times during the database developing processes. Besides, the database is highly dependent on the materials in the battery so that the database used by the battery management IC has to be recreated even the materials of battery are just a subtle difference, as forgoing description. Worse still, the database will be not updated if an end consumer user does not make the battery be fully charged and completely discharged. As a result, the power management program will provide incorrect remaining charge information for the user when the battery is aging.

Another conventional embodiment is the open circuit method. The encounter difficulties are similar to the forgoing method of dynamic discharge cutoff voltage. It needs a lot of time to develop a database which also material related.

Still another conventional embodiment is disclosed by Barsoukov et al, on U.S. Pat. No. 6,832,171 with a title “Circuit and Method for Determining Battery Impedance Increasing with Aging.” In the method a current flowing through the battery is analyzed if a transient condition due to change of current is occurring and determined when the transient condition has ended. A voltage of the battery is measured while a steady current is being supplied by the battery. The present depth of discharge is accessed to determine a corresponding value of open circuit voltage. And then the internal is computed by dividing the difference between the battery voltage and the open-circuit voltage by an average value of the steady current. The remaining run-time is then determined by using a total zero current capacity, integrating the current to determine a net transfer of charge from the battery, determining total run time, determining the duration of the integrating, and determining the remaining run-time by subtracting the duration from total run-time. The method demand a database established by the battery being fully charged and completely discharged for hundreds of time.

An object of the present invention is to overcome above problems.

### SUMMARY OF THE INVENTION

A device for predicting remaining capacity of battery and a method for the same is disclosed. The device built in or external connected to a battery pack comprises a database and a capacity derived algorithm program. The database is stored in a writable-and-erasable non-volatile memory, wherein the database comprises an open-circuit voltage table, a current-gain table and energy-capacity converted equations. The open-circuit voltage table has data of open-circuit voltages of a battery measured at predetermined temperatures Tⱼ and at predetermined depths of (% DOEₙ) denoted as OCV (Tⱼ, DOEₙ). The current-gain table contains data of current-gains, denoted as IGAIN (DOEₙ). The energy-capacity converted equations contains a correcting factor so as to solve the problem when the remaining capacity calculated based on the coulomb counter is inconsistent with a remaining capacity obtained based on the terminal voltage and the predicting discharging curve where n is a nature number and j is from 1 to 3.

The capacity derived algorithm program executed by a microprocessor. The program generates a discharging curve according to the cell temperature and load accessed and corrects the database according to the battery voltage and the discharging curve and the coulomb counter and then reports a remaining capacity.

In the method, the steps include the steps of: (a) detecting a load current and a surface temperature T_{B} of the battery; (b) generating a predicting discharging curve which depicts the relationship between voltages and DOEₙ based on the database and the data detected in the step (a); (c) fetching a terminal voltage and then determining a DOE % value according to the predicting discharging curve and the terminal voltage of the battery according to the coulomb counter neither in a discharging mode nor a relax mode; (d) correcting the database if the status information is in a discharging mode or in a relax mode and then obtaining the DOE % value according to the updated database.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a system of predicting remaining capacity of a battery by a self-training algorithm program using the cell voltage, cell temperature and accessed load as inputting parameters.

FIG. 2 shows apparatus for predicting remaining capacity of battery in accordance with the present invention.

FIG. 2A illustrates an OCV discharging curve and a constant load current discharging curve used to calculate the current-gain value at 50% DOE.

FIG. 2B depicts a schematic diagram of a constant load current discharging curve shifted from an OCV discharging curve.

FIG. 3 shows a flow chart of the self-training algorithm program according to the present invention.

FIG. 4A shows an interpolation method used to derive a discharge curve while a detected cell temperature is not equal to the temperature in the OCV table.

FIG. 4B shows the DOE % value obtained by coulomb counter is not equal to that of derived from the discharging curve and the cell voltage detected

### DESCRIPTION OF THE PREFERRED EMBODIMENT

As aforementioned conventional techniques, no matter what the methods of predicting cell capacity according to prior art including the dynamic discharging voltage cutoff method or open-circuit voltage method is taken, the whole processes of them demand the battery being fully charging and discharging repeatedly for hundreds of times and still if the end user does not often do the fully charging and discharging process, then the database will not be updated, results in predicting incorrectly predicting the residual capacity. The problem will be more serious while the material of the battery has aged.

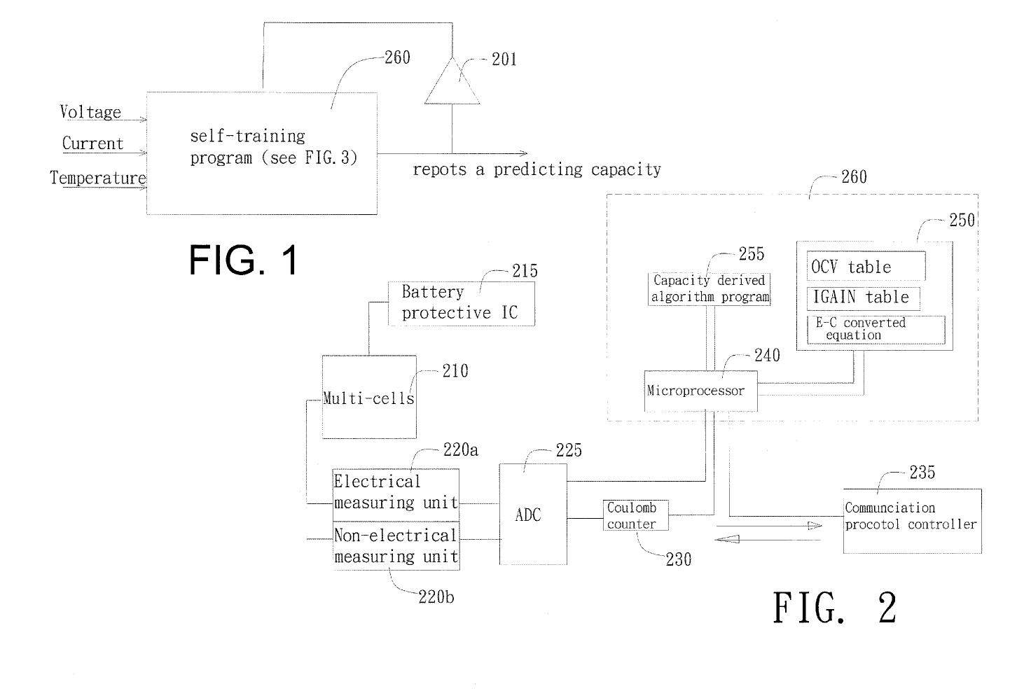

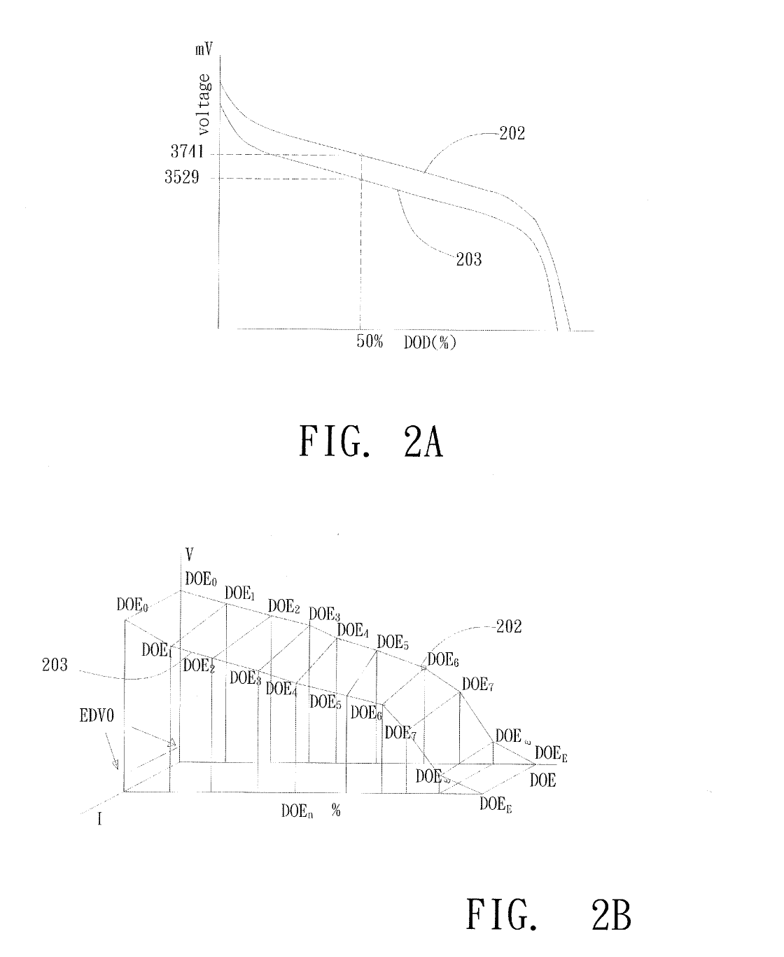

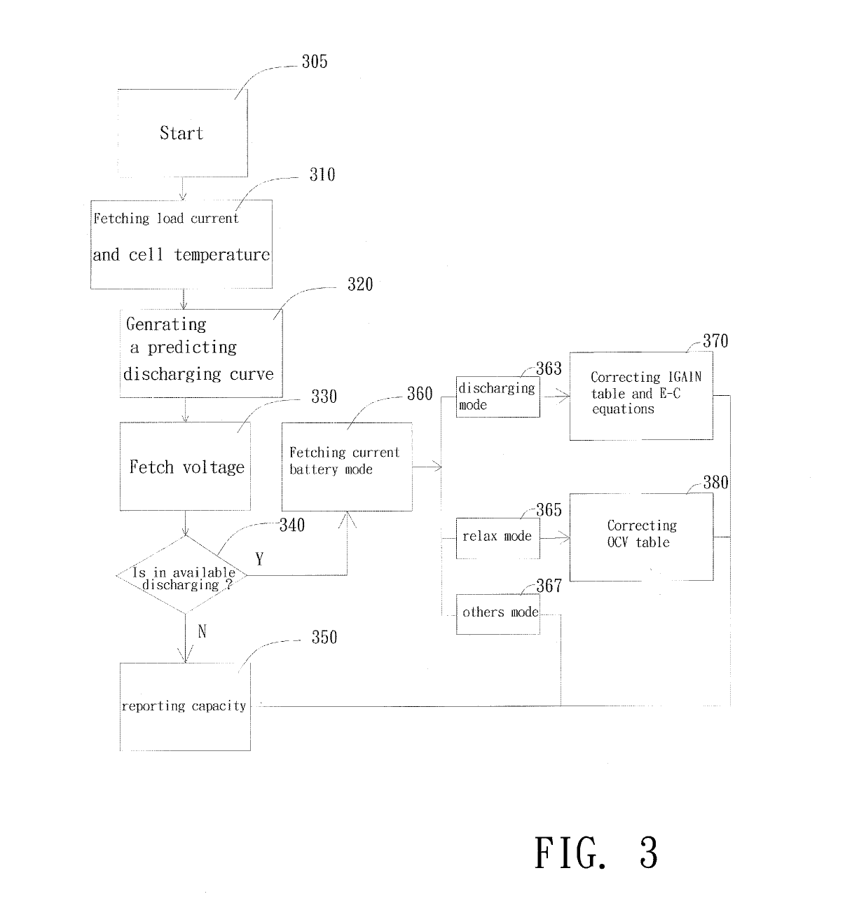

The present invention provides an algorithm to predict remaining capacity of a battery by using the cell temperature (surface temperature), accessed load current, and cell voltage as input parameter, as is shown in FIG. 1. A device 260 for predicting a remaining capacity may embed in a battery pack or externally connected to the battery pack, as shown in FIG. 2. The device includes an algorithmic program 255, a database 250, and a microprocessor 240 so as to carry out a self-training procedure. The microprocessor 240 may includes in the battery pack. The input terminals of the apparatus 260 are provided to retrieve the battery voltage, the surface temperature of the battery and the accessed load to perform a self-training procedure, please see FIG. 3. Upon the self-training procedure accomplished, the database is updated and the residual charge capacity of the battery is predicted accordingly. Thereafter, the new basic data in the database are then provided for the next self-training procedure after a predetermined time according the buffer 201, as shown in FIG. 1. Each cycle of the self-training procedure takes only about 1 second or several seconds.

As shown in FIG. 2, the battery pack comprises multi-cells 215, a battery protective circuit 210, an electrical measuring unit 220a, and a non-electrical measuring unit 220b, an analog-to-digital (ADC) converter 225, a coulomb counter 230, and a battery communicative protocol controller 235.

The electrical measuring unit 220a is to detect the terminal voltage of the multi-cells 215, and the current output. The non-electrical measuring unit 220b is to detect the surface of multi-cells 215. The forgoing temperature, terminal voltage and the current all will be converted to digital data by an ADC converter 225 for microprocessor. Aside from that, the current is also counted by the coulomb counter 230 and the resulted outputting data by the device 260 will provide to battery communicative protocol controller 235.

In accordance with the present invention, to carry out the present invention, a database 250 has to prepared or provided in advance. The database includes (1) an open-circuit voltage table (OCV Table), (2) a current-gain table, and (3) capacity-energy converted equations. The open circuit voltage hereinafter is to indicate that the natural discharging of the battery is simulated by using a small discharging rate rather than absolutely natural discharging the battery through the open circuit.

The steps of OCV table established include: fully charging a battery and then discharging the battery with a small but constant discharging current such as 1/20 C or below at a predetermined constant ambient temperature wherein C is the specified capacity of the battery. The voltage and the surface temperature of the battery will be measured when a predetermined depth of energy (DOE %) is reached. The processes of fully charging and discharging to the predetermined DOE % are performed repeatedly so as to get the DOE %, OCV relationships at the predetermined ambient temperature.

For instance, the ambient temperature is set to 5° C. and the battery is fully charged and then it is discharging by a rate of about 1/20 C to 10% DOE and then the surface temperature and the voltage are measured. The surface temperature may be higher than the ambient such as 6° C. Thus a first data is OCV1 (10% DOE, T₁) where T₁=6° C.

The other data of the OCV table with different ambient temperatures such as 25° C., and 45° C. may be obtained using the steps as above so as to get the data OCV2 (10% DOE, T₂) and OCV3 (10% DOE, T₃). Generally, the surface temperatures of the battery measured are different from the ambient temperature set. The data may be adjusted by using the interpolation or extrapolation method to the assigned temperatures so as to reduce the data number.

The data of OCV table with different DOE % values can be obtained as forgoing steps. Moreover, the discharge curve is steeper at the neighbor of fully charge point (0% DOE) and EDV point (end of discharge voltage), therefore the DOE % values for such region are preferred denser than others. Table 1 is an example of the initial OCV table with an unit (mV), as follows:

TABLE 1

| | T | | |
|---|---|---|---|
| DOE % | 5° C. | 25° C. | 45° C. |
| 5 | 4129 | 4151 | 4164 |
| 10 | 4086 | 4108 | 4119 |
| 15 | 4048 | 4069 | 4077 |
| 20 | 4010 | 4032 | 4039 |
| 30 | 3948 | 3966 | 3969 |
| 40 | 3895 | 3912 | 3915 |
| 50 | 3825 | 3851 | 3855 |
| 60 | 3792 | 3802 | 3803 |
| 70 | 3774 | 3778 | 3780 |
| 80 | 3755 | 3757 | 3761 |
| 85 | 3729 | 3737 | 3738 |
| 90 | 3688 | 3710 | 3710 |
| 95 | 3676 | 3677 | 3685 |

The current-gain table (IGAIN table) is obtained by the following steps: firstly, the battery is fully charged and then discharged with a higher but constant discharging rate such as 0.2 C or 0.5 C. The expression is:

V(DOE,T,I)=OCV(DOE,T)+I

The equation represents that the IGIN is equivalent to a resistance and the terminal voltage of the battery is level shifted up or down while the battery is discharged using a higher discharging rate.

An exemplary of the IGAIN obtained is shown in FIG. 2 A. The curve 202 is a OCV discharging curve and the point P corresponding to OCV (30° C., 50% DOE)=3741 mV and the discharging curve 204 is obtained by using a discharging current 1000 mA. The point P′ corresponding to (30° C., 50% DOE) is of 3529 mV so that the IGAIN (30° C., 50% DOE) is:

IGAN=3741−3529/1000=0.212

IGAIN table is acquired by discharging the battery from a known DOE % value point to a target % DOE value by a constant discharging current. Upon reaching the target, a voltage is measured. For example, a battery is fully charged, at which 0% DOE, and then discharged by a rate such as 0.2 C to 5% DOE and a voltage is measured. Then the battery is discharged from 5% DOE to 10% DOE by the same discharging current, then another voltage is measured. The processes repeat to discharge the capacity downward to every target DOE %. The IGAIN data for a discharging rate of about 0.2 C is denoted as IGAIN_{0.2}.

Similarly, another set of IGAIN data may be obtained by a different discharging rate such as 0.3 C or o.5 C and they as denoted as IGAIN_{0.3} and IGAIN_{0.5}

However, to simplify the database, only one IGAIN value is taken for each target % DOE of the IGAIN table though different discharging rates may generate different IGAIN values at the same % DOE value. According to an embodiment of the present invention, for each assigned % DOE but different discharging rates, just only one IGAN value is selected and recorded. An IGAN value is selected when they have a common feature but an average or a middle value of IGAN values may be recorded when the common feature cannot be determined.

An exemplary of the IGAIN table is shown in table 2, as follows:

IGAIN table
Depth of Energy(DOE %) vs. IGAN

| | | | | | | | | |
|---|---|---|---|---|---|---|---|---|
| DOE % | 5 | 10 | 15 | 20 | 30 | 40 | 50 | 60 |
| IGAN | 0.063 | 0.057 | 0.058 | 0.058 | 0.060 | 0.063 | 0.056 | 0.055 |
| DOE % | 70 | 80 | 85 | 90 | 95 | | | |
| IGAN | 0.062 | 0.063 | 0.060 | 0.051 | 0.061 | | | |

As to (3), the capacity converted equation is expressed as energy

$${E}_{ma x} = \frac{Δ Cap}{Δ ( {DOE}_{X} - {DOE}_{X - 1} )} , \qquad ( 2 )$$

Where Eₘₐₓ is the maximum energy the battery contained therein.
ΔCₐₚ is the capacity difference between two % DOE values.

Fully charged (FCC) equation:

FCC=Eₘₐₓ×DOE_{E}×ω (3)

where ω is a correcting factor and DOE_{E} is a depth of energy corresponding to the end of discharging voltage.

Remaining capacity equations are expressed as: (equations (4)&(5))

RM_{@Initial}=Eₘₐₓ×(DOE_{E}−DOE_{ε})×ω (4)

Where DOE_{ε}is the depth of energy corresponding to the current voltage of the battery.

RSOC_{@Initial}=RM_{@Initial}/FCC (5)

The self-training procedure is shown in FIG. 3, a flow chart thereof. It starts from the step 305, which claims the steps of procedure start therefrom.

Next, in the step 310, the current load and the surface temperature of the battery is measured by the electrical measured unit 220a and non-electrical measured unit 220b, respectively. The data measured hereinafter all will be converted by ADC 225 for microprocessor 240 to access.

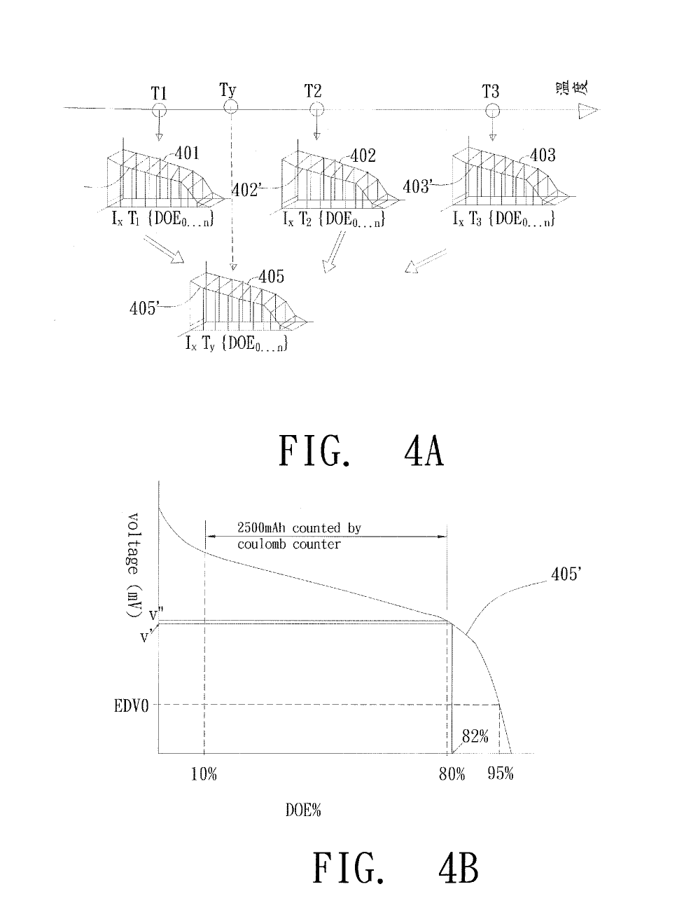

Turning to the step 320, the battery management program 260 will generate an OCV discharging curve according to the temperature measured and the bases data in the OCV Table 1 of the database. If the temperature is equal to T1, T2 or T3 in the Table 1, then the discharging curve 401, 402 or 403 will be generated according to the data, depicted in the OCV Table 1. Otherwise, when the temperature measured is T_{y} within the specification of the battery, but T_{y}≠T₁, T₂ or T₃ then the curve 405 is generated by a method of interpolation or extrapolation for each data point in the Table 1, as shown in FIG. 4A. For example, the V(DOE₁, T_{y}) is obtained according to V(DOE₁, T₁), V(DOE₁, T₂) and V(DOE₁, T₃) using an interpolation method. Other data are gotten by a similar process.

Still referring to FIG. 4A, the OCV discharging curves 401, 402, and 403 are adjusted according to the IGAIN Table 2, load current detected and the formula (1) to obtain the constant predicting discharge curves 401′, 402′, and 403′. Accordingly, if the detected temperature is Ty then, the predicted discharging curve is generated by the interpolation or the extrapolation based on the data on curves 401′, 402′, and 403.′

Thereafter, a step 330 is followed. A voltage of the battery is measured by the electrical detected modules 220a. The present % DOE is obtained according to the predicted discharging curve at step 320 and the detected temperature as is shown in FIG. 4B.

Turning to the step 340, the step is to determining whether the status of the battery is complied with available discharging conditions. The conditions include the discharging current over a predetermined criteria and the temperature within a range which battery can be operated normally as well as the delayed time. The predetermined criteria of the discharging current is at least over 0.1 C and the temperature detected is within 0° C. to 60° C. Preferably, the temperature is demanded to be within 5° C. to 50° C. Moreover, the accuracy point of the capacity for discharging must be known before performing a discharging process. The delayed time for a battery to perform the self-training algorithm from a known discharging point should not over one day to prevent the known discharging point become inaccuracy since the battery will self-discharging.

When the status of the battery does not satisfy the conditions of available discharging, the step is jumped to the step 350 to report the remaining capacity according to the % DOE value obtained in the step 330.

On the contrary, when the condition is true, the step goes to step 360, which is to accumulate the charges released from the known discharging point of the battery using the coulomb counter to determine which modes that the battery runs accordingly, wherein the modes include a discharging mode, a relax mode and the others through a comparison using the value of charges accumulated at currently and at the last time by the coulomb counter. The time interval may be 1 s or 10 s.

mined according to accumulated charges counted by the coulomb will be compared with the % DOE value by correspondence the terminal voltage in the step 330 with the predicted discharging curve in the step 320.

An example is shown in FIG. 4B, the value read from the coulomb counter is 2500 mAh from a known discharging point 10% DOE and Eₘₐₓ at that time is known to be of 3571 mAh. Therefore, the % DOE value will be 80% DOE according to equation (2). The voltage corresponding to the 80% DOE of the predicted discharging curve 405 is V″. If the voltage V″=V′, no correction is demanded where V′ is detected at step 330.

However, if V″≠V′ such as V″>V′, as shown in FIG. 4B, then the % DOE corresponding the voltage V′ to the predicted discharging curve 405′ is of 82%. According to the energy converted equation (3), the Eₘₐₓ is determined to be 3472 mAh.

After that, the step turns to step 350, to calculate the capacity of the battery. As shown in FIG. 4B, FCC is determined to be:

FCC=Eₘₐₓ×95%=3298 mAh;

The remaining capacity RM is determined to be:

RM=Eₘₐₓ(95%−82%)=451 mAh;

On the other hand, since the starting discharging point is known to be10% DOE, where E_{MAX} has a value of 3571 mAh and then, accordingly, the capacity of the battery FCC is of

FCC=Eₘₐₓ×95%=3392 mAh;

The remaining capacity RM is of

RM=Eₘₐₓ(95%−10%)=3035 mAh; and

since the accumulated charges released counted by the coulomb counter from the known points 10% DOE to a second points 80% DOE, are of 2500 mAh and thus accordingly, the RM would be of:

RM=3035−2500=535 mAh; therefore, according to the equation (4) the correcting factor ω=1.186.

As the mode of the battery is in a relax mode, as shown in step 365, the open-circuit voltage (OCV) table I in the database will be requested to be updated. The conditions of the relax mode include that the discharging current is lower than a second criteria and sustain for 30 min and/or above. The second criteria are set to be one twentieth of the full battery capacity.

The correction of the OCV table I is to correct the OCV (DOE, T) according to the newly detected temperature at the surface of the battery by the step 310 and the % DOE in accordance with the. step 330 to update the values of all OCV (DOE, T). Thereafter, the step goes to step 350 to calculate the capacity of the battery according to the updated OCV table 1, and the information collected at step 310.

As the mode of the battery is neither in relax mode nor in discharging mode then the step directly goes to the step 350 to calculate the capacity of the battery at the present time.

The benefits of the present invention:

(1) The database is easily to develop;

(2) The processed time spent for every self-training cycle is about 5 s to 10 s, even more, the time spent required may be 1 or 2 s after the database is developed.

(3) The remaining capacity of the battery can be determined at every self-training cycle if the DOE % value or energy is known at the starting discharging point. The database will be updated if the battery runs in the discharging mode or relax mode.

(4) In comparison with that of the prior art, the time spent for a database development according to the present is much less. According to the present invention, the database build demands the battery fully charged and discharged for several hundred of times.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A method of predicting remaining capacity of a battery by self-training, said method comprising the steps of:
(a) providing a database having an open-circuit voltage (OCV) table, a current-gain (IGAIN) table and energy-capacity converted equations wherein said OCV table depicts corresponding relationships between a plurality of open-circuit voltages (OCV) of said battery measured at predetermined temperatures Tⱼ versus a plurality of depths of energy (% DOE_{1:E}) at a predetermined temperature Tⱼ, so that each element in said OCV table is expressed by OCV(Tⱼ, DOEₙ), where j of Tⱼ is at least three, and said Tⱼ within a temperature range that said battery is able to be used normally and 1:n represents from 1 to E through n, and said IGAIN table depicts a plurality of IGAIN_{1:E} values versus a plurality of % DOE_{1:E} by one to one corresponding relationship and expressed as IGAIN (DOEₙ) and said energy-capacity converted equations contains a correcting factor;
(b) measuring a load current I pulled out from said battery and a surface temperature T_{B} of said battery;
(c) generating OCV discharging curves each corresponding to said Tⱼ with voltages on a Y-axis versus % DOE_{1:n} on an X-axis according to said OCV table;
(d) generating a predicting discharging curve according to said OCV discharging curve, and corrected by said current I according to an equation of V(DOEₙ, T_{B}, l)=OCV(T_{B}, DOEₙ)+I×IGAIN (DOEₙ);
(e) measuring a terminal voltage of said battery to determine a % DOE value according to said terminal voltage detected and said predicting discharging curve;
(f) judging if a status information of said battery satisfying available discharging conditions;
(g) determining a remaining capacity of said battery according to said % DOE value at current time if said battery doesn't satisfy available discharging conditions an then ending;
(h) correcting said IGAIN table so that and said predicting discharging curve is corrected accordingly, and a correcting factor in said energy-capacity converted equations is corrected, if said status information of said battery is in a discharging mode and then determining a remaining capacity of said battery according to said corrected predicting discharging curve and said corrected correcting factor and then ending;
(i) correcting said OCV table if said status information of said battery is in a relaxing mode so that said OCV discharging curve is corrected and said predicting discharging curve is corrected thereto too and then a remaining capacity of said battery is determined according to said corrected predicting discharging curve and said corrected correcting factor and then ending; and
(j) doing nothing on said OCV table, said IGAIN table and said correcting factor and determining a remaining capacity of said battery according to a current predicting discharging curve if said status information of said battery is is neither in said discharging mode nor said relax mode.

2. The method of predicting remaining capacity of a battery by self-training according to claim 1 wherein said conditions of said available discharging include (1) said surface temperature within a temperature range which said battery is able to be used normally and the self-training time within 24 hours after the battery is fully charged.

3. The method of predicting remaining capacity of a battery by self-training according to claim 1 wherein said conditions of said discharging mode include a discharging current at least 0.1 C, where C is a capacity after fully charged.

4. The method of predicting remaining capacity of a battery by self-training according to claim 1 wherein said conditions of said relaxing mode include a discharging current small than 0.05 C and sustain for 30 min where C is a capacity after fully charged.

5. The method of predicting remaining capacity of a battery by self-training according to claim 1 wherein said correcting factor is bigger than 1 if a % DOE value read according to a coulomb counter versus said predicting discharging curve is smaller than a % DOE obtained from said measured voltage versus said predicting discharging curve.

6. The method of predicting remaining capacity of a battery by self-training according to claim 5 wherein said correcting factor is to make a remaining capacity calculated based on said coulomb counter consistent with a remaining capacity obtained based on said terminal voltage and said predicting discharging curve.

7. The method of predicting remaining capacity of a battery by self-training according to claim 1 wherein said correcting factor in said energy-capacity converted equations is set when a remaining capacity counted according to coulomb counter from a discharging point whose DOE value is known is different from a remaining capacity according to said terminal voltage and said predicting discharging curve.

8. The method of predicting remaining capacity of a battery by self-training according to claim 1, wherein the temperatures Tⱼ include three temperatures selected from 0° C. to 60° C.

9. The method of predicting remaining capacity of a battery by self-training according to claim 1, wherein an interpolation method on the or exploration method according to at least two of said predicting discharging curves at said Tⱼ is taken when T_{B}≠Tⱼ.

10. The method of predicting remaining capacity of a battery by self-training according to claim 1 wherein said energy-capacity converted equations includes one maximum capacity converted equation, one fully charged equation and two remaining capacity equations, and said correcting factor is located at one of said remaining capacity equations.

11. A device for predicting remaining capacity of battery, said device built in or external connected to a battery pack, comprising:
a database stored in a writable-and-erasable non-volatile memory module, wherein said database comprises an open-circuit voltage table, a current-gain table and energy-capacity converted equations wherein said open-circuit voltage table has data of open-circuit voltages (OCV) of a battery measured at predetermined temperatures Tⱼ and predetermined energies of depth of energy (% DOEₙ) denoted as OCV(Tⱼ, DOEₙ) and said current-gain table contains data of current-gains, denoted as IGAIN (DOEₙ) each of them mapping to one value of % DOE in said open-circuit voltage table and said energy-capacity converted equations contains a correcting factor where n is from 1 to m and j is from 1 to 3;
a capacity derived algorithm program executed by a microprocessor to report a remaining capacity of a battery to be predicted according to a battery surface temperature, a load-current, and a terminal voltage detected, and said database.

12. The device for predicting remaining capacity of battery according to claim 11 wherein said surface temperature, said load-current, and said database are used to generate a predicting discharging curve.

13. The device for predicting remaining capacity of battery according to claim 11 wherein said remaining capacity is obtained according to a terminal voltage detected and said predicting discharging curve.

14. The device for predicting remaining capacity of battery according to claim 11 wherein accumulated charges by said coulomb counter from a known discharging point is used to check the correctness of said database, and updated them if there are inconsistent between a DOE value predicted by said terminal voltage associated with said predicting discharging curve and a DOE value obtained by said coulomb counter from a known discharging point.

15. The device for predicting remaining capacity of battery according to claim 14 wherein said correcting factor is used to eliminate said inconsistence when said inconsistence is found by multiply said remaining capacity is obtained according to said terminal voltage detected and said predicting discharging curve with said correcting factor.
